(19) United States
(12) Patent Application Publication
(10) Pub. No.: US 2023/0150803 A1
(43) Pub. Date: May 18, 2023

(54) TOWER CRANE WITH ADJUSTABLE COUNTER-BALLAST

(71) Applicant: LIEBHERR-WERK BIBERACH GMBH, Biberach an der Riss (DE)

(72) Inventor: Christoph EIWAN, Ummendorf (DE)

(21) Appl. No.: 17/906,610

(22) PCT Filed: Mar. 17, 2021
(86) PCT No.: PCT/EP2021/056770

§ 371 Date: Sep. 16, 2022

(30) Foreign Application Priority Data
Mar. 18, 2020 (DE) 10 2020 107 417.4

(51) Int. Cl. B66C 23/76

(52) U.S. Cl. CPC B66C 23/76

(57) ABSTRACT

The invention relates to a tower crane having a slewing platform, an adjustable boom articulated in a derricking manner on the slewing platform and counter-ballast mounted on the slewing platform, characterized in that an adjusting mechanism is provided that permits a positional change to the counter-ballast independent of the luffing angle of the adjustable boom.

### TECHNICAL FIELD

The disclosure relates to a tower crane having a slewing platform, an adjustable boom articulated in a derricking manner on the slewing platform and counter-ballast mounted on the slewing platform.

### BACKGROUND AND SUMMARY

Adjustable boom cranes are known on which the counter-ballast is coupled to the adjustable boom via fixed kinematics. By means of the kinematics, a movement of the adjustable boom is transferred to the counter-ballast, which is consequently displaced on the slewing platform depending on the boom angle. The aim of these constructions is to reduce the required adjusting gear power for the boom movement. They also attempt to optimise the load on the crane tower, in particularly for different states and load cases, by displacing the counter-ballast. An essential common feature of all such constructions is that the load-relieving of the boom and the optimisation of the tower load can only be carried out for a predefined crane type through the displacement of the counterweight depending on the boom length.

FIG. 1 shows, by way of example, the plot of the inherent weight moment, more particularly of the movable parts of the upper crane (line 1, line 2), with the aim of optimising the upper crane inherent weight moment without payload (line 4). If the crane were to have an immovable counter-ballast, line 4 would extend parallel to line 1 (boom inherent weight moment). With a movable counter-ballast (line 2), however, it is possible to set the inherent weight moment of the upper crane (line 4) such that it is practically constant. With the sketched payload curve (line 0) there is, for a boom angle of 15 degrees (maximum outreach) to approximately 50 degrees (kink of the payload curve), also an almost constant upper crane moment (line 5), the magnitude of it approximately the same as the inherent weight moment of the upper crane without payload (line 4).

If something on the crane configuration changes, for example a change to the length of the adjustable boom, this optimum with constant upper crane inherent weight moment cannot be achieved by means of the invariable kinematics. Line 4 has an incline depending on the boom angle Alpha. A change to the counterweight merely causes a parallel displacement of the line 4.

If, alongside this optimisation problem, one also considers the influence of the wind load on the upper crane and crane tower for an in-operation or out-of-operation setting, the problem becomes more complex. In the past, the described optimisation solution was considered to be sufficient not least because the out-of-operation wind load (storm out of operation) was practically the same worldwide. With the recent introduction of wind zones combined with the need to adapt the out-of-operation wind load to the place of installation of the crane, the optimisation problem has become more complicated still. Furthermore, in the past, the significance of the in-operation load with respect to the out-of-operation loads has always shifted from the non-operation load cases to the in-operation load cases as the size of the crane increased. Conversely, the smaller the crane, the more significant the out-of-operation load cases are for the crane tower.

The problem addressed by the present application is that of modifying a crane of the generic type such that an optimisation of the position of the counter-ballast is also possible depending on the crane state, the crane configuration and the operating conditions.

The disclosure proposes providing an adjusting mechanism for the tower crane, which adjusting mechanism permits a positional change of the counter-ballast independent of the luffing angle of the adjustable boom. The already mentioned adjusting mechanisms always provided a mechanical coupling between adjustable boom and counter-ballast, and therefore a positional change of the counter-ballast could only be achieved by changing the luffing angle of the adjustable boom. The present application differs from such a solution and proposes instead an independent adjusting mechanism in order for a positional change of the counter-ballast to be made independently of an actuation, i.e. derricking movement of the adjustable boom.

For the basic inventive concept, it does not matter whether there is a kinematic coupling between adjustable boom and counter-ballast. However, it is essential to the disclosure that the position of the counter-ballast can also be changed while a luffing angle remains constant. It is not counter to the inventive concept, however, if a change to the luffing angle of the adjustable boom leads to a coupled change to the counter-ballast position.

According to a first variant, a complete decoupling of the counter-ballast and adjustable boom is proposed, i.e. the position of the counter-ballast remains constant in the event of a change to the luffing angle, and can only be varied by the adjusting mechanism. A specific exemplary implementation of the adjusting mechanism can be a movable ballast receiving device for receiving the counter-ballast. The ballast receiving device may be a trolley which is mounted relative to the crane slewing platform in a displaceable manner on same.

In some embodiments, a displacing movement of the ballast receiving device or trolley is in a horizontal direction in order to keep the load on the trolley drive which occurs during displacement, and the energy requirement associated therewith, as low as possible. The use of a rope drive or spindle drive to move the ballast receiving device or trolley is possible.

As an alternative to the presented variant, there can also be a mechanical kinematic coupling between adjustable boom and counter-ballast, as before. For example, the use of an articulated linkage for coupling is conceivable. In particular 4-joint kinematics are conceivable which provide a coupling between counter-ballast and boom by means of a swing arm-coupling rod combination. By means of this linkage, a luffing angle change of the adjustable boom is transferred to the counter-ballast, as a result of which a positional displacement of the counter-ballast is triggered. As the luffing angle of the adjustable boom increases, the distance of the counter-ballast to the crane tower reduces. The type and scope of the positional displacement of the counter-ballast depends on the kinematics of the used linkage, in particular on the location of the articulation and pivot points and the length dimensions of individual rods. In view of this, it is proposed to equip at least one of these coupling rods with the adjusting mechanism according to the disclosure. By means of the adjusting mechanism, the axial length of the at least one rod can be changed, as a result of which the position of the counter-ballast can be influenced, specifically also without a change to the luffing angle of the adjustable boom.

The length of at least one rod of the linkage can be changed by means of an integral hydraulic cylinder or alternatively by means of a spindle drive.

It is also conceivable that an adjusting mechanism, for example hydraulic cylinder, is provided to change the position of at least one articulation and/or hinge point of the linkage.

As an alternative to using an articulated linkage for mechanical coupling between adjustable boom and counter-ballast, use of a coupling rope can also be intended, which as a rule creates a mechanical connection between adjustable boom and counter-ballast by means of one or more deflecting rollers. Here, too, a change to the luffing angle of the adjustable boom leads to a positional displacement of the counter-ballast, wherein the type and extent of the positional change depends significantly on the length of the coupling rope and the position of the deflecting roller. With this in mind, it is proposed that by means of the adjusting mechanism according to the disclosure, a change to the length of the coupling rope and/or alternatively a positional change of at least one deflecting roller is effected. Through this intervention in the kinematics of the rope mechanism, a positional change of the counter-ballast can be achieved without a change to the luffing angle of the adjustable boom.

### BRIEF DESCRIPTION OF THE FIGURES

Further properties of the disclosure are explained in more detail hereinafter on the basis of an exemplary embodiment shown in the drawings. Shown are in:

FIG. 1 a schematic representation of the inherent weight plot of movable parts of an upper crane depending on the boom angle;

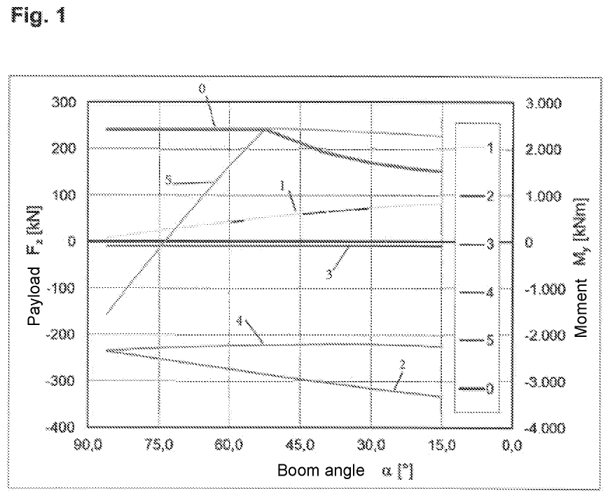

FIG. 2 a first exemplary embodiment of the crane according to the disclosure with 4-joint kinematics

FIG. 3 a second exemplary embodiment of the crane with cable hoist system,

FIG. 4 a third exemplary embodiment of the tower crane with rigid coupling between boom and counter-boom

FIG. 5 a slightly modified embodiment of the tower crane according to FIG. 4 and

FIG. 6 another exemplary embodiment of the tower crane with a completely variable coupling between boom and counter-boom.

### DETAILED DESCRIPTION

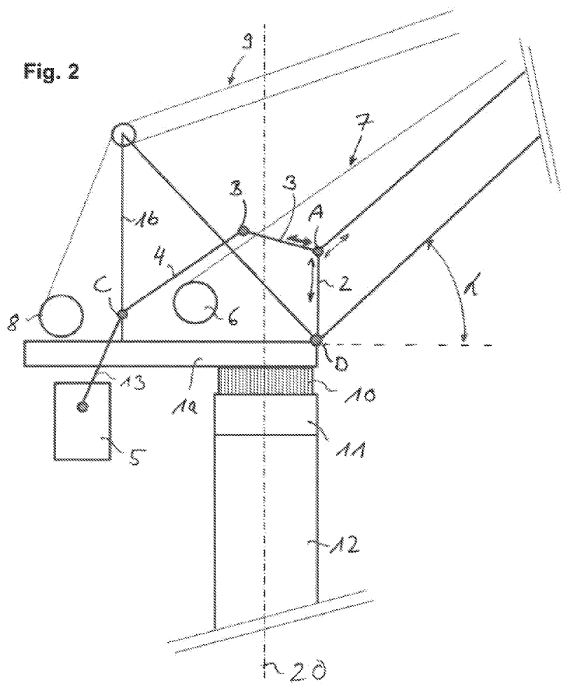

FIG. 2 shows an adjustable boom crane. The tower crane comprises a crane tower on the tip of which a slewing platform 1a is rotatably mounted by means of the slewing ring support 11 and the slewing ring 10. On the slewing platform 1a, the adjustable boom is mounted in a derricking manner about a horizontal axis. The luffing angle α can be set by means of the adjusting gear 8 and the luffing rope 9. For the lifting work, the lifting rope 7 extends from lifting gear 6 mounted on the slewing platform 1a to the boom tip.

The adjustable boom 2 is mechanically coupled by means of a 4-joint transmission to the counter-ballast 5, which consists of the swing arm formed by the adjustable boom 2, the coupling rod 3, the counter-ballast swing arm 4 and the connection device 13, which may be a hook. The two swing arms 2, 4 are hinged in a manner articulated via their articulation points C, D on the slewing platform 1a and on the A-frame 1b of the adjusting gear. The coupling rod 3 is connected in an articulated manner via pivot points A, B to the swing arms 2, 4. The connection device 13 can also be connected in an articulated manner to the swing arm 4 and to the ballast 5.

The displacement of the counter-ballast 5 in the event of a change to the angle α is carried out dependent on the lengths of the two swing arms 2, 4, the length of the coupling rod 3 and the position of the bearing points C, D of the two pivot arms 2, 4 on the crane structure 1a, 1b. The distance of the counter-ballast 5 from the crane axis of rotation 20 is a non-linear function of the boom angle α, which is specified by the adjusting gear 8.

The inherent weight moment of the displaceable counter-ballast 5 can now be carried out via a change to the inherent weight and via a change to the parameters of the 4-joint transmission. According to the disclosure, therefore, an adjusting mechanism is added to change the length of the coupling rod 3. This can be carried out through the integration of a hydraulic cylinder or spindle drive the actuation of which influences the length of the coupling rod 3. It is also conceivable that the coupling rod 3 is designed similarly to a tension lock so that the length of the coupling rod 3 can be manually changed. It is just as possible for the coupling rod to be provided with a plurality of bearing bores offset in the axial direction. The working length of the coupling rod can be changed through the appropriate choice of the bearing bore for assembly on the articulation and pivot points A, B.

An intervention in the kinematics is also possible by changing the length of the two swing arms 2, 4, e.g. by displacing the two bolting points A, B along the structural parts of the two components 2, 4 in the direction of the indicated arrows.

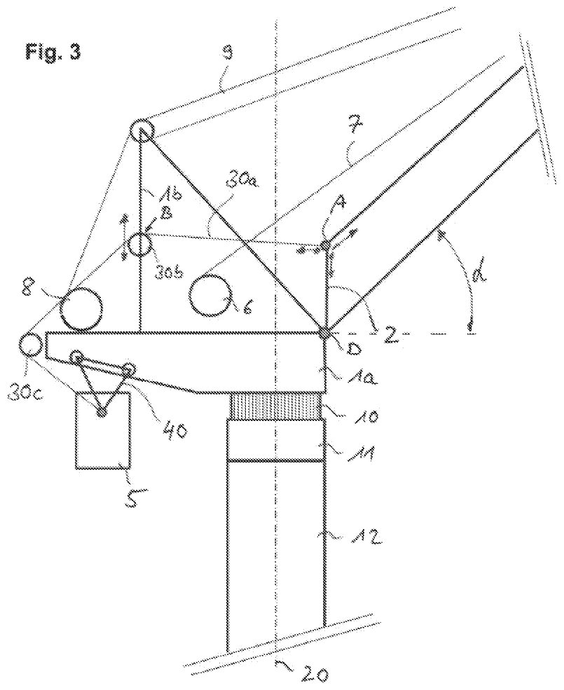

A second exemplary embodiment for the crane according to the disclosure is shown in FIG. 3. Identical parts here are shown with identical reference characters. Compared to the crane from FIG. 2, the mechanical coupling between adjustable boom 2 and counter-ballast 5 is achieved differently here. A trolley 40 is used here, to which the counterweight 5 is fastened and which is moved on an inclined plane by means of a pulley system 30a. The counter-ballast 5 is displaced dependent on the length of the boom swing arm 2, the length of the coupling rope 30a, the inclination of the travel path of the trolley 40 and the position of the bearing points of the deflecting rollers 30b, 30c as well as the position of the boom swing arm 2 on the frame 1a. The distance of the counter-ballast 5 from the crane axis of rotation 20 is a non-linear function of the boom angle α, which is specified by the adjusting gear 8.

The inherent weight moment of the displaceable counter-ballast 5 can be carried out via a change to the inherent weight and via a change to the parameters of the pulley system 30a. This can be done by changing the length of the coupling rope 30a. A corresponding adjusting mechanism, for example a hydraulic cylinder, can change the rope length while the crane is in operation.

An intervention in the kinematics and thus a change to the counter-ballast position can however also be carried out by displacing the bolting point A of the coupling rope 30 with the boom swing arm 2 along the structural parts of the boom 2 in the direction of the suggested arrows. This could also be carried out in an automated manner by means of a suitable adjusting mechanism.

Also conceivable is a displacement of the position of the deflecting roller 30b along the structural parts of the A-frame 1b in the direction of the suggested arrows or a displacement of the position of the deflecting roller 30c along the structural parts of the slewing platform 1a. The displacement of the deflecting rollers can also be implemented by means of a suitable adjusting mechanism, for example by means of a hydraulic cylinder.

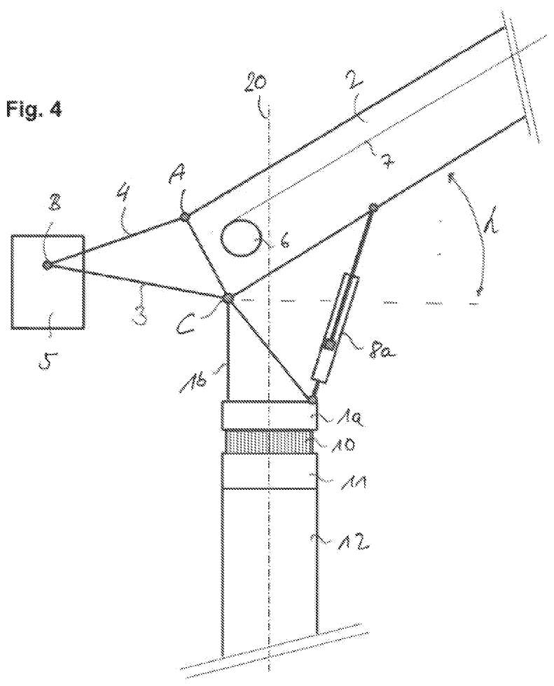

A third embodiment can be taken from FIG. 4. On this crane, an adjusting cylinder 8a is used to change the angle α of the adjustable boom 2. The adjustable boom 2 is mounted not on the slewing platform 1a, but rather on the A-frame 1b. With this solution, a rigid coupling between counter-ballast 5 and boom 2 is furthermore used. A movable swing arm 4 is used, to which the counterweight 5 is fastened and which can be adjusted by means of a coupling rod 3. The rotation point of the swing arm 4 is the joint A. The pivot points of the coupling rod 3 are labelled B, C. The movement is relative to the boom 2 (not to the frame (1b)). The distance of the counter-ballast 5 from the crane axis of rotation 20 is a function of the boom angle α which is specified by the stroke of the adjusting cylinder 8a.

The inherent weight moment of the displaceable counter-ballast 5 can be carried out by changing the inherent weight and by changing the length of the coupling rod 3, similar to that proposed in the solution of FIG. 2. Specifically, the length of the coupling rod 3 can be set by means of an integral hydraulic cylinder or spindle drive. A manual change to the coupling rod length is also conceivable if this is designed in a similar manner to a tension lock or is provided with a plurality of bearing bores offset in the axial direction.

Particularly on the crane structure shown in FIG. 4, it makes sense to change the length of the coupling rod 3 during the switch to the out-of-operation state. On adjustable boom cranes, the boom 2 is brought into a relatively steeply pitched position (α=ca. 70°) during switching to non-operation. As a result, in this solution the counter-ballast 5 moves relatively close to the crane axis of rotation 20 and as a result can no longer develop an all too great inherent weight moment. However, this would be helpful to counter the out-of-operation wind load with a moment in the event of an inflow from behind.

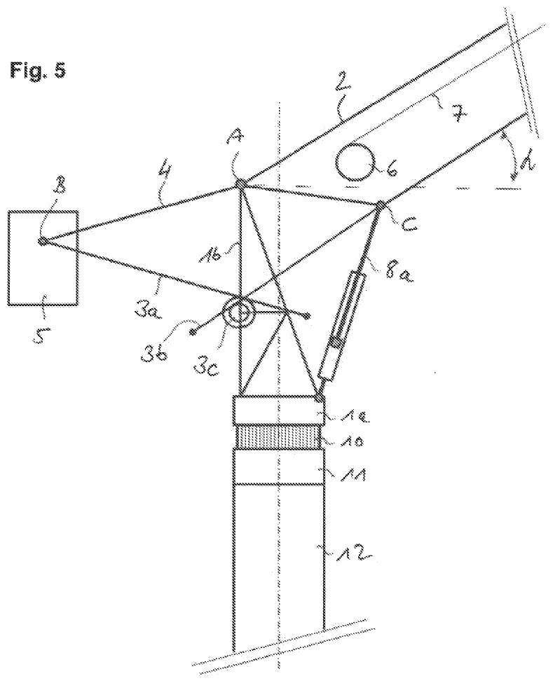

A variation on this solution is shown in FIG. 5. In this variant, the coupling rod 3 is divided into two partial components 3a, 3b. The coupling and corresponding movement of the counter-ballast 5 is adapted to the movement of the boom 2 by means of a transmission 3c in an appropriate ratio. To obtain the necessary relative movement, the coupling rod 3a is connected no longer to the boom 2 but to the frame 1b. The pivot points of the swing arms 2, 4 is labelled A. The hinge point of the coupling rod 3a is labelled B and the hinge point of the coupling rod 3b is labelled C. The pivot points C, D also represent the pivot points of the adjusting cylinder 8a.

The above solutions are characterised in that the movement of the counter-ballast 5 is mechanically coupled to the movement of the boom 2. If it is possible to omit the load-relieving of the luffing drive, the counter-ballast 5 can, according to an embodiment of the disclosure, also be directly displaced by means of a separate drive-based adjusting mechanism. The optimisation problem is thus only limited to minimising the tower load.

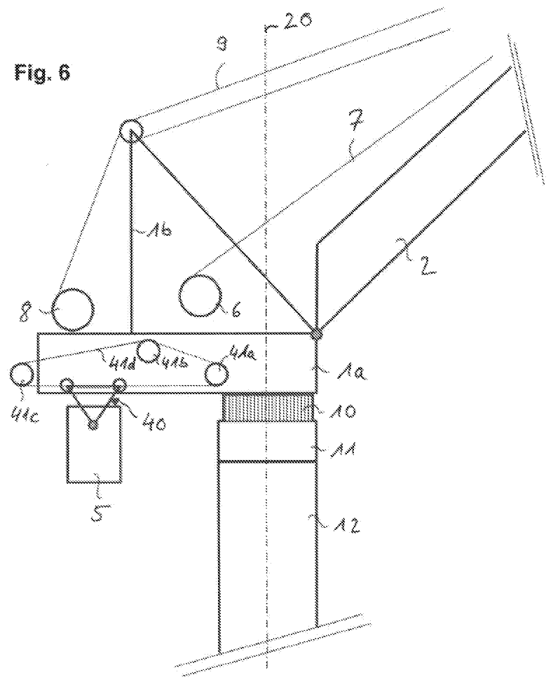

To keep the load for this drive and the energy requirement associated therewith low, the counterweight 5 should be moved as horizontally as possible. This can be achieved with a driven trolley 40 (see FIG. 6) on which the counterweight 5 is fastened and which is moved e.g. by means of a rope drive comprising the rope 41d and the required rollers 41a, 41b, 41c. Alternatively, a spindle drive could also be used. By means of the rope drive, the trolley 40 and thus the counterweight 5 can be displaced horizontally on the slewing platform 1a, as a result of which the distance of the counter-ballast 5 to the crane axis of rotation 20 can be set completely independently of the angle α.

The advantages of this solution may include one or more of the following:
the position of the counter-ballast 5 in the state “crane in operation” would be independent of the position in the “out-of-operation setting”
the position of the counter-ballast 5 in the state “crane in operation” would be adjustable in any relationship to the boom angle α and
the position of the counter-ballast 5 could be optimally and individually adapted to any boom length.

1. A tower crane having a slewing platform, an adjustable boom articulated in a derricking manner on the slewing platform and a counter-ballast mounted on the slewing platform,
wherein
an adjusting mechanism is provided that permits a positional change to the counter-ballast independent of the luffing angle of the adjustable boom.

2. The tower crane according to claim 1, wherein a trolley, which receives the counter-ballast, is provided as the adjusting mechanism, which trolley is mounted relative to the crane slewing platform in a movable manner on same.

3. The tower crane according to claim 2, wherein the trolley can be moved in the horizontal direction relative to the slewing platform.

4. The tower crane according to claim 2, wherein the trolley can be moved by means of rope drive or a spindle drive.

5. The tower crane according to claim 1, wherein the counter-ballast is coupled to the adjustable boom by means of an articulated linkage, and by means of the adjusting mechanism the length of at least one of the rods of the linkage and/or the position of at least one hinge point of the linkage can be changed.

6. The tower crane according to claim 5, wherein the length of the at least one rod or the location of a hinge point can be set by means of an integral hydraulic cylinder or a spindle drive.

7. The tower crane according to claim 1, wherein the counter-ballast is coupled to the adjustable boom by means of a coupling rope, wherein by means of the adjusting mechanism the length of the coupling rope and/or the position of at least one of the deflecting rollers for the coupling rope can be changed.

8. The tower crane according to claim 7, wherein a hydraulic cylinder is provided as adjusting mechanism for changing the rope length or the position of a deflecting roller.
